(19) United States
(12) Patent Application Publication
(10) Pub. No.: US 2007/0119385 A1
(43) Pub. Date: May 31, 2007

(54) Novel animal lead

(76) Inventor: Adam Slank, Fort Collins, CO (US)

Correspondence Address: SANTANGELO LAW OFFICES, P.C., 125 SOUTH HOWES, THIRD FLOOR, FORT COLLINS, CO, 80521, US

(21) Appl. No.: 11/605,818

(22) Filed: Nov. 28, 2006

Related U.S. Application Data
(60) Provisional application No. 60/779,315, filed on Mar. 3, 2006.
(60) Provisional application No. 60/739,617, filed on Nov. 28, 2005.

(51) Int. Cl. A01K 27/00

(52) U.S. Cl. 119/776

(57) ABSTRACT

At least one embodiment of the inventive technology is an animal lead that can be released from an attached animal (e.g., a dog) upon pulling a trigger loop near a hand loop. Certain embodiments may provide a mechanically advantaged release that enables facile, perhaps even one fingered release of, e.g., a strong, pulling dog.

This patent application is a U.S. non-provisional application that claims priority to U.S. provisional patent application, 60/779,315, filed Mar. 3, 2006, and U.S. provisional patent application, 60/739,617, filed Nov. 28, 2005, each patent application incorporated herein by reference.

### BACKGROUND OF THE INVENTION

Generally this invention relates to a load control system, such as an animal control system. More particularly, it relates to a load control system that provides mechanically advantaged release that enables facile, perhaps even one fingered release of, e.g., a strong dog.

It is often desired to quickly release an animal that is restrained by a lead system operated by a human. Whether as a reward for a dog being trained, or in order to release a police attack dog on a perpetrator of a crime (as but two examples), it may often be desired to release an animal from a lead.

Often, in the past, to release an animal from the lead it is necessary to manually disconnect the attachment between the collar and the lead. This is impractical, slow, awkward and/or difficult in many situations because the animal and the person holding the leash must come together, the detachable part located on the collar, and, often, both hands must be used. However, certain innovations in animal lead technology now obviate this process and allow for remote (i.e., away from the animal) release of a retained animal (i.e., an animal attached to the lead and controllable by a human at an opposite end of the lead). However, problems may still inhere in such technologies—for example, it may be difficult to release a strong animal that is pulling on the lead. At least one embodiment of the inventive technology claimed herein seeks to remedy this problem.

### SUMMARY OF THE INVENTIVE TECHNOLOGY

At least one embodiment of the inventive technology is an animal lead that can be released from an attached animal (e.g., a dog) upon pulling a trigger loop near a hand loop. Certain embodiments may provide a mechanically advantaged release that enables facile, perhaps even one fingered release of, e.g., a strong dog.

### BRIEF DESCRIPTION OF THE FIGURES

Of course, the included drawings and descriptions are only intended to demonstrate possible embodiments. They are not meant to limit the scope of the inventive technology in any way.

FIG. 1 shows a first portion of the lead apparatus as it may appear in at least one embodiment of the inventive technology.

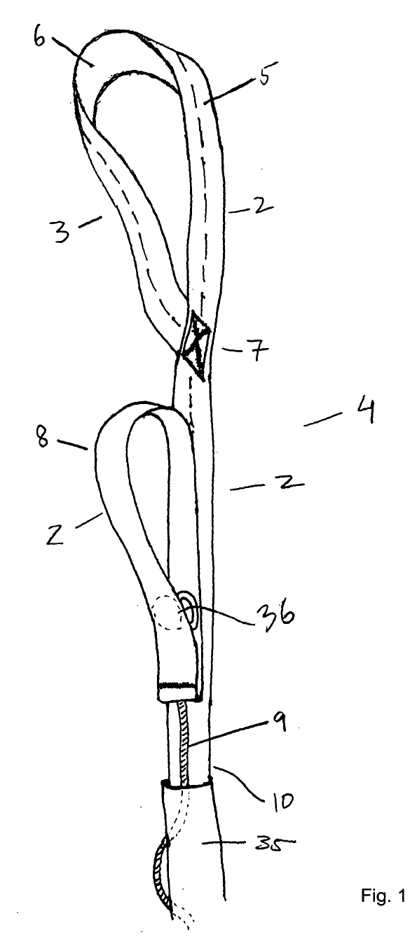

FIG. 2 shows a second portion of the lead apparatus in animal retention configuration, as it may appear in at least one embodiment of the inventive technology.

FIG. 3 shows a second portion of the lead apparatus in animal release configuration, as it may appear in at least one embodiment of the inventive technology.

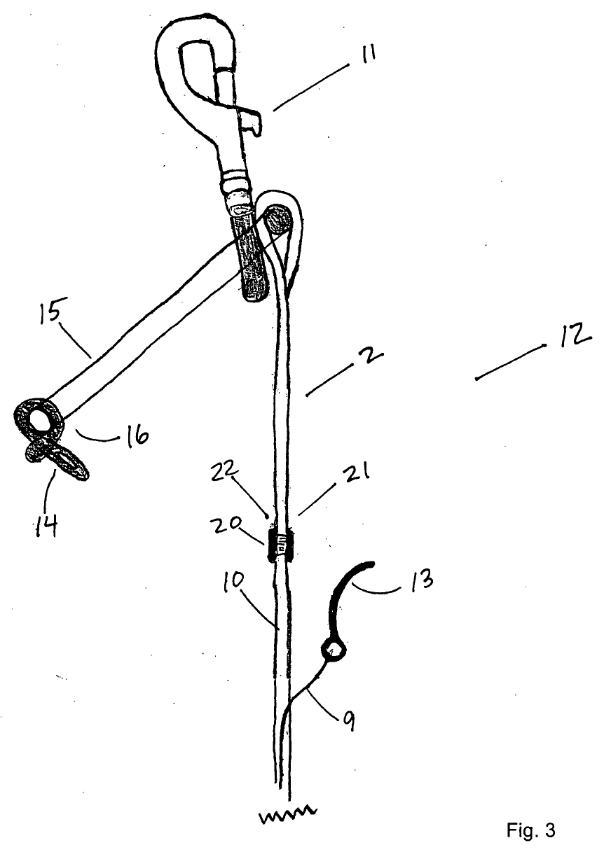

FIGS. 4A and 4b each show a second portion of the lead apparatus (animal release configuration in FIG. 4A; animal retention configuration in FIG. 4B), as it may appear in at least one embodiment of the inventive technology.

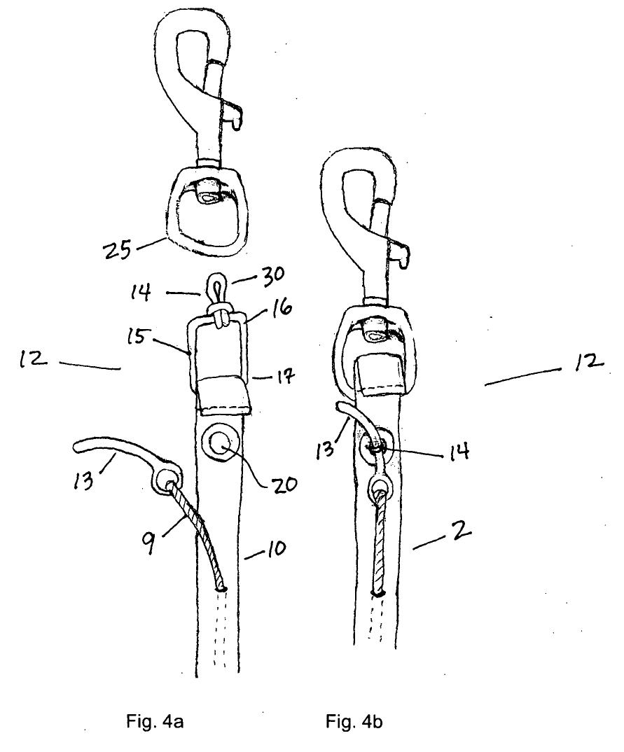

FIG. 5 shows a dog, a dog owner, and the lead apparatus in at least one embodiment of the inventive technology, immediately after disengaging the primary lead line from the dog.

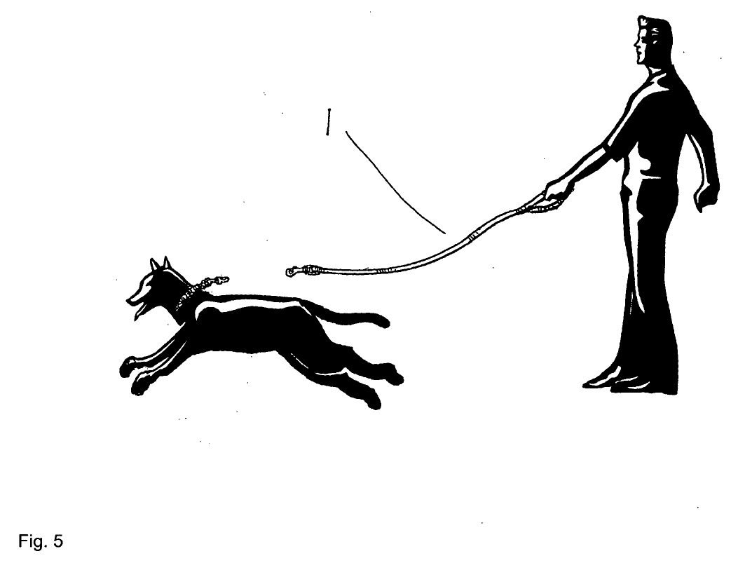

### DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

At least one embodiment of the inventive technology includes an animal lead apparatus 1 manufactured, in part, from tubular material such as webbing 2. The lead features a novel hand loop 3 configured to allow the user to ergonomically hold the lead. More specifically, the hand loop is established at a first end portion 4 of the lead that is graspable by a human (e.g., a dog owner) and made of material, such as webbing, having first and second hand loop material sides 5, 6. Such sides may face each other at an attachment site 7 that forms the hand loop. Such may result in a half twist of the webbing in the hand loop itself. Further, the loop may be sized such that when the loop is properly held in the hand of a user, the attachment site rests substantially in the palm of the user, thereby allowing the user to pinch, if desired, a single piece of webbing (that the loop may be at the end of) between the thumb and index finger (e.g., a portion of the lower part of the index finger that is proximate the thumb). Such may enable convenient and comfortable operation of the trigger loop 8 by that hand.

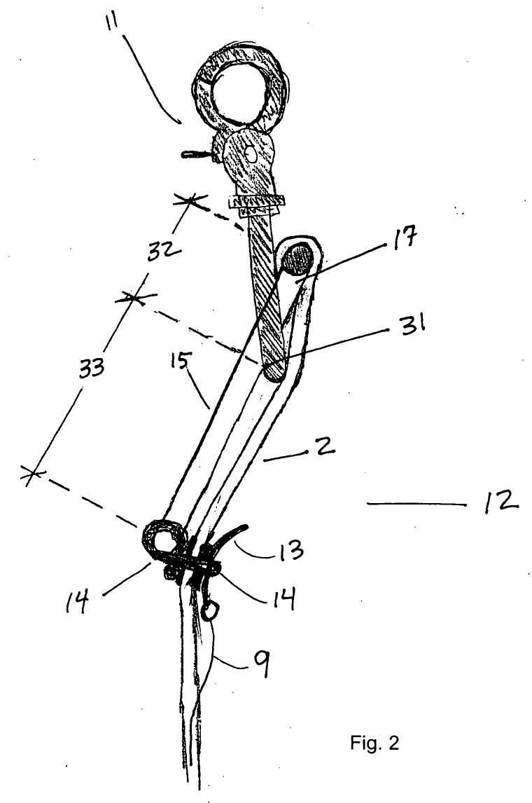

As mentioned, in at least one embodiment of the inventive technology, a trigger loop 8 operable by a human user user of the lead is established substantially at a first end portion 4 of the lead (e.g., as where it is made available near the hand loop). The trigger loop may be attached to a trigger line 9 (including but not limited to braided trigger line) that may enter the interior of a primary lead line 10 (e.g., tubular webbing) that itself is established from the first end portion 4 of the lead to an animal attachment component 11 that is attachable to an animal and that is established at the second end portion 12 of the lead when the lead is in an animal retention configuration (e.g., when an animal is controllably secured using the lead attached as in e.g., FIG. 2). The trigger line travels towards the second end portion of the lead and terminates at a pin 13 (perhaps only after exiting the material making up the primary lead line). This pin may be releasably engaged with a retention loop 14 which itself may be attached to a leverage release part 15 at a first leverage release part end 16. This pin is used to releasably maintain the connection formed between the human and the animal.

In at least one embodiment of the inventive technology, there is, as mentioned, a leverage release part 15. It may have a second leverage release part end 17 that may be pivotally attached to the primary lead line 10 substantially at the second end portion 12 of the lead; it may pivot about an axis that is perpendicular to the longitudinal axis of the lead when the lead is drawn tight. The leverage release part 15 may have any shape, whether rectangular, partial rectangular, circular, partial circular, oval, partial oval, as but a few examples. The leverage release part 15 and a portion of the primary lead line can retain the animal attachment component 11 (e.g., any of a variety of snap connectors, as but a few examples) and indeed does so when the lead is in an animal retention configuration. Upon pulling of the trigger loop 8 and release of the pin 13 from the retention loop 14, the now “freed” leverage release part 15, under tension from a load such as a pulling animal, will pivot through part of the animal attachment component, thereby releasing the animal attachment component 11 and the animal (or, more generally, load) attached thereto. Of course, as used herein, the term component can include more than one part.

In at least one embodiment of the inventive technology, the lead may include an animal attachment component 11 that may be attached to an animal. Such component may connect directly to an animal or the animal's collar, e.g.. The leverage release part 15 may have attached thereto at, e.g., a first leverage release part end 16, a retention loop 14 that is made from retention loop material that passes through the primary lead line at a retention loop pass through site 20 (e.g., a grommetted hole) on the primary lead line; at such site, the primary lead line may have a first primary lead line side 21 and a second primary lead line side 22. The pin 13 may pass through the retention loop 14 on the first primary lead line side 21 and the retention loop 14 may be attached to the leverage release part on the second primary lead line side 22 (when the apparatus is in animal retention configuration). Of course, when the pin 13 is disengaged from the retention loop 14, as by pulling the trigger loop 8, the release part (in a preferred embodiment, a leverage release part 15), now allowed to pivot under the tension of a load such as a pulling animal, may pivot and pass through a part 25 of the animal attachment component 11, thereby releasing the animal attachment component 11 and any load (e.g., an animal) attached thereto.

In order to configure the apparatus in animal retention configuration, an initial, partial engagement may be completed upon passage of the retention loop 14 through the retention loop pass through site 20; complete engagement may then occur upon passage of the pin 13 through the retention loop 14 on the side of the retention loop pass through site 20 that is opposite the leverage release part 15. Of course, as mentioned, a load (e.g., a pulling dog) may be release upon disengagement of the pin 13 from the retention loop 14 by pulling the trigger loop 8.

When the leverage release part 15 is affixed with a retention loop 14, it may be of a number of materials, including elastic (e.g., rubber). Affixing the leverage release part 15 with a retention loop 14 may be accomplished upon wrapping the unattached loop around the release part, then threading it back under itself so that tension (and friction) may secure it to the release part and so that it establishes a loop 30 that may then be passed through a hole at the retention loop pass through site 20. This is merely one of many ways in which a retention loop 14 can be detachable from the leverage release part 15. Of course, because it is detachable, it can be easily replaced, even in the field.

Again, in at least one embodiment of the inventive technology, once a retention loop 14 is through a hole at a retention loop pass through site 20 and a sufficient portion of it appears on the other side of the primary lead line, a partial engagement has occurred. Complete engagement occurs upon passage of pin 13 through a loop 30 of the retention loop 14 that is passed through the primary lead line at the retention loop pass through site 20. In at least one embodiment, release may then be accomplished, as mentioned, by a user at the end of the lead system pulling the trigger loop 8 sufficiently to release the pin 13, thereby allowing the leverage release part 15 to pivot and pass through part of the animal attachment component 11, leading to release of the animal. The animal (e.g., a dog) can now run as instructed or desired.

In at least one embodiment of the inventive technology, there is provided a mechanical lever advantage. Such may be provided by the use of leverage release part 15, particularly where, in an animal retention configuration, and when a restrained animal tensions the primary lead line, the leverage release part 15 contacts a portion of the animal attachment component 11 at a site 31 on the leverage release part 15 that is closer to the second leverage release part end 17 than it is to the first leverage release part end 16 (i.e., distance 32 is less than distance 33).

In at least one embodiment of the inventive technology, such leveraged configuration significantly lowers the force experienced by the user of the lead system in pulling the trigger loop to release the pin, thereby releasing the animal, while still providing a high strength connection. As can be appreciated, because of such leveraged configuration, the force on the pin is less than it would be otherwise, and, for such reason, the pin can be more easily removed with a simple pull of the trigger loop. As those familiar with releasable leads know, a strong dog that is pulling at the end of a lead can exert a force that, without a leveraged configuration, can make the pin difficult to release. A leveraged release configuration makes the pin more easily releasable with a strong dog; typically only a single finger is needed.

Although, indeed, there may be a concern that a leveraged configuration may result in a force on the pin itself that, with small or weak dogs, or dogs that are not pulling, might be so small as to introduce a risk that the pin might disengage at times other than when the trigger loop is pulled, such risk can be minimized, perhaps even eliminated, upon use of an elastic retention loop. Such a retention loop 14, when selected such that it is deformed (stretched) when it is attached to the leverage release part 15 and the lead system is in animal retention configuration, assures that the force retaining the pin is never less than a certain value. This constant, force “floor,” particularly when applied directly by a material that has frictive coefficients that are greater than, e.g., carbon steel (e.g., as where the retention loop is made from elastic), can preclude the problem of unintentional release of an attached animal.

In at least one embodiment, as mentioned, the inventive technology allows the user to pull a trigger line 9 that itself may run through the interior channel of the primary lead line material (e.g., webbing) to break the connection near the animal. A user may pull the line 9 by directly pulling a trigger loop 8 through which a finger may be placed for quick triggering and release. Such release can be performed without requiring the user remove his or her grip from the hand loop 8 of the lead. Further, as mentioned, the afore-described mechanical advantage can render the process simple even when the force (e.g., as provided by a large dog) is significant.

One way of making an embodiment of the preferred technology may involve stitching. More particularly, it may involve sewing a hand loop on one end of tubular webbing and sewing a pivotable release part (again, which may be levered upon final construction) on the other end. Manufacturing methods may involve passing the material through the release part and sewing it to itself to contain this release part. The fabric can be assembled with, e.g., heat seal, stitch, or rivet techniques in any manner.

A grommet can be formed through the lead to form a reinforced hole at the retention loop pass through site 20. Line (a broad term wherever used, including any type of conventionally described line braided or not, and webbing, cord, rope or cable, inter alia) can be threaded, during manufacture, through the interior of at least part of the primary lead line 10 such that it enters in the vicinity of the hand loop 8, and exits in the vicinity of the retention loop pass through site 20. Of course, these are only possible entry/exit sites.

As mentioned, in at least one embodiment, the end of the trigger line proximate the human user of the lead (as opposed to the end distal the human user of the lead) can terminate at a trigger loop 8, a broad term that includes any part that can be pulled by a single finger. As such, it may be closed or open, large enough to accept more than one finger, or small, such that it can accept only one finger. It may be rigid (e.g., metal or plastic); it may be non-rigid (e.g., looped webbing or cord). The other end of the line (that is distal from the human user) can be threaded through the primary lead line material 10 (e.g., webbing) and exit therefrom near the pin 13 to which it may be attached.

The animal attachment component 11 can be fabricated from metal as available as cast products, other rigid materials, or as fabric in a variety of methods well known in the art. The components of the lead system can be manufactured in a wide variety of shapes and thicknesses, and with a wide variety of materials. Some of those materials include nylons, natural fabrics, metal, rubbers, and leather. The invention, or parts thereof, may be manufactured, in part, using sewing machines, of course, but its manufacture and assembly can be accomplished in a variety of ways that will be apparent to those skilled in the art.

It is of note that in certain embodiments, upon release, the animal attachment component 11 stays attached to the animal (e.g., because it is attached to a collar, or perhaps even because it includes a collar itself). However, such is not a feature of all embodiments, as indeed, in some embodiments, in order to meet a goal of not leaving any devices (e.g., a collar) on the animal (e.g., that could be grabbed by an individual the animal is attempting to hold), nothing is left on the dog after release.

Of additional note is that the pin 13 may be curved (including any structure that does not have a straight, linear appearance) or straight. The term pin is broad, and is intended to include any of a variety of objects, regardless of length, to which a trigger line 9 can be attached. It may be a parachute pin, as but one example. Additional embodiments may include a deformable (e.g., “scrunchable”) material 35 forming a collar of sorts established around part of the lead, perhaps in the vicinity of the trigger loop 8 and/or the point at which line may enter webbing.

The apparatus may include an unintentional animal release preventer 36 operable by a human so as to prevent release of the animal at times other than intended. Such may be, but is not limited to, a safety button configured to releasably attach the trigger loop to the primary lead line. Of course, Velcro™ may be used instead, as but one example of an alternative for the unintentional animal release preventer 36. A related step includes assuring that the unintentional animal release preventer 36 is in deactivated mode, which step may include reconfiguring the unintentional animal release preventer 36 from activated mode to deactivated mode (e.g., by unsnapping a button).

Of course, the inventive technology may also include inventive methods. At least one embodiment of the inventive technology is a method of controlling an animal with an animal lead apparatus 1 having a first end portion 4 graspable by a human and a second end portion 12 attachable to an animal. The method may include the steps of: attaching the second end portion 12 of the animal lead apparatus 1 to the animal; grasping the first end portion 4 of the animal lead apparatus at a hand loop 8 established substantially at the first end portion 4; controllably retaining the animal with a primary lead line 10 established from the first end portion 4 to an animal attachment component 11 established at the second end portion 12 of the animal lead apparatus 1 when the animal lead apparatus 1 is in an animal retention configuration; assuring an unintentional animal release preventer 36 is in deactivated mode, pulling, with mechanical advantage, a trigger loop 8 established substantially at the first end portion 4; retracting a trigger line 9 and a pin 13 attached thereto, and releasing (e.g. pivotally releasing, as where a release part pivots) the animal attachment component 11 and the animal attached thereto.

It should be understood that the inventive technology includes methods and apparatus that relate to controllably releasing a load that is not limited to animals. As such, this specification should be considered as disclosing technologies that are not “animal limited”, including “dog limited.” Thus, this specification discloses terms presented herein with the term “load” replacing the words “animal” and “dog.”

As can be easily understood from the foregoing, the basic concepts of the present invention may be embodied in a variety of ways. It involves both animal control techniques as well as devices to accomplish the appropriate animal control. In this application, the control techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this nonprovisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “preventer” should be understood to encompass disclosure of the act of “preventing”—whether explicitly discussed or not—and, conversely, were there effectively disclosure of the act of “preventing”, such a disclosure should be understood to encompass disclosure of a “preventer” and even a “means for preventing” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the animal control devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An animal lead apparatus having a first end portion graspable by a human and a second end portion attachable to an animal, wherein said apparatus comprises:
a hand loop established substantially at said first end portion and made of material having a first hand loop material side and a second hand loop material side;
a trigger loop operable by said human and established substantially at said first end portion;
a primary lead line established from said first end portion to a animal attachment component established at said second end portion of said animal lead apparatus when said animal lead apparatus is in an animal retention configuration;
a trigger line attached to said trigger loop; and
a pin attached to said trigger line and releasably engaged with a retention loop that is attached to a leverage release part at a first leverage release part end,
wherein said retention loop is made from retention loop material that passes through said primary lead line at a retention loop pass through site on said primary lead line,
wherein said primary lead line has a first primary lead line side and a second primary lead line side at said retention loop pass through site,
wherein said pin passes through said retention loop on said first primary lead line side and said retention loop is attached to said leverage release part on said second primary lead line side,
wherein said leverage release part and a portion of said primary lead line retain said animal attachment component of said animal lead apparatus when said animal lead apparatus is in said animal retention configuration,
wherein said leverage release part has a second leverage release part end that is pivotally attached to said primary lead line substantially at said second end portion,
wherein, when said animal lead apparatus is in an animal retention configuration and said animal tensions said primary lead line, said leverage release part contacts a portion of said animal attachment component at a site on said leverage release part that is closer to said second leverage release part end than it is to said first leverage release part end, and
wherein said first and second hand loop material sides of said material of which said hand loop is made face each other at an attachment site that forms said hand loop.

2. An animal lead apparatus as described in claim 1 wherein said animal lead apparatus comprises a dog lead apparatus.

3. An animal lead apparatus as described in claim 1 wherein primary lead line comprises webbing.

4. An animal lead apparatus as described in claim 1 wherein said trigger line comprises a braided trigger line.

5. An animal lead apparatus as described in claim 1 wherein said trigger loop comprises looped webbing.

6. An animal lead apparatus as described in claim 1 wherein retention loop is detachable from said leverage release part.

7. An animal lead apparatus as described in claim 6 wherein said retention loop comprises an elastic retention loop.

8. An animal lead apparatus as described in claim 1 wherein said pin comprises a parachute pin.

9. An animal lead apparatus as described in claim 1 wherein said pin comprises a curved pin.

10. An animal lead apparatus as described in claim 1 further comprising an unintentional animal release preventer operable by said human.

11. An animal lead apparatus as described in claim 10 wherein said unintentional animal release preventer comprises a safety button configured to releasably attach said trigger loop to said primary lead line.

12. An animal lead apparatus as described in claim 1 wherein said retention loop pass through site is a grommetted hole.

13. An animal lead apparatus as described in claim 1 wherein said trigger line passes through at least a portion of said primary lead line.

14. An animal lead apparatus as described in claim 1 wherein said leverage release part is substantially rectangular in shape.

15. An animal lead apparatus as described in claim wherein said site on said leverage release part that is closer to said second leverage release part end than it is to said first leverage release part end contacts said animal attachment component substantially at an end of said animal attachment component.

16. A method of controlling an animal with an animal lead apparatus having a first end portion graspable by a human and a second end portion attachable to an animal, said method comprising the steps of:
attaching said second end portion of said animal lead apparatus to said animal
grasping said first end portion of said animal lead apparatus at a hand loop established substantially at said first end portion;
controllably retaining said animal with a primary lead line established from said first end portion to a animal attachment component established at said second end portion of said animal lead apparatus when said animal lead apparatus is in an animal retention configuration;
assuring an unintentional animal release preventer is in deactivated mode,
pulling, with mechanical advantage, a trigger loop established substantially at said first end portion;
retracting a trigger line and a pin attached thereto, and
releasing said animal attachment component and said animal attached thereto,

17. A method of controlling an animal with an animal lead apparatus as described in claim 16 wherein said step of assuring an unintentional animal release preventer is in deactivated mode comprises the step of reconfiguring said unintentional animal release preventer from activated mode to deactivated mode.

18. A method of controlling an animal with an animal lead apparatus as described in claim 17 wherein said step of reconfiguring said unintentional animal release preventer from activated mode to deactivated mode comprises the step of unsnapping a button that releasably attaches said trigger loop to said primary lead line.

19. A method of controlling an animal with an animal lead apparatus as described in claim 16 wherein said step of releasing said animal attachment component comprises the step of pivotally releasing said animal attachment component.

20. A method of controlling an animal with an animal lead apparatus as described in claim 16 wherein said step of grasping said first end portion of said animal lead apparatus at a hand loop comprises the step of grasping said first end portion of said animal lead apparatus at a hand loop made from material having first and second hand loop material sides, and whose said first and second hand loop material sides face each other at an attachment site that forms said hand loop.
